(19) United States
(12) Patent Application Publication
(10) Pub. No.: US 2025/0013934 A1
(43) Pub. Date: Jan. 9, 2025

(54) POWERED RICKSHAWS AND SYSTEMS AND METHODS FOR INTEGRATION

(71) Applicant: Drophawk Technologie, LLC, Sheridan, WY (US)

(72) Inventor: Dante Wooten, Sheridan, WY (US)

(21) Appl. No.: 18/762,801

(22) Filed: Jul. 3, 2024

Related U.S. Application Data
(60) Provisional application No. 63/511,748, filed on Jul. 3, 2023.

(51) Int. Cl. G06Q 30/0207; G06Q 10/02; G06Q 30/0283

(52) U.S. Cl. CPC G06Q 30/0213; G06Q 10/02; G06Q 30/0284

(57) ABSTRACT

The disclosed technology includes a method for providing on-demand transit services comprising receiving, by a computing system, information relating to a voucher from a user device, wherein the voucher is from a vendor, the voucher being exchangeable by a user for a discount on a cost of a ride from the on-demand transit service; receiving, by the computing system, a request for a ride from the on-demand transit services from the user device, the request including at least a current location of the user device, a transit destination requested by the user, and information relating to the voucher; determining, by the computing system, a cost for the ride from the on-demand transit service is based at least in part on the information relating to the voucher; and sending, by the computing system, a request to a transit service provider device.

### CROSS-REFERENCE TO RELATED APPLICATIONS

This application claims the benefit of U.S. Provisional Patent Application No. 63/511,748, filed Jul. 3, 2023, which is incorporated by reference herein in its entirety.

### TECHNICAL FIELD

Various embodiments of the invention relate to powered rickshaws and, more particularly, to systems and methods for enhancing the integration of powered rickshaws into micro-mobility on demand transportation environments. The invention may apply to vehicular devices or transportation environments.

### BACKGROUND

As urban populations rise, the need for micro-mobility transportation continues to increase to meet the demands of the growing population's short-range travel through urban settings. Current systems in place for urban travel include private individual-owned transportation, ride-sharing applications, public transport, and self-piloted transportation devices. Each of these current systems pose benefits but also significant issues for their users or for the environment at large. The wide use of private individual-owned transportation, such as personal vehicles, and ride-sharing applications in densely populated urban areas cause significant traffic congestion. Traffic congestions lead to significant losses in time for travelers. Further high-volume usage of personal vehicles negatively impact environmental conditions due to the Carbon emission rates associated with the vehicles. These environmental impacts are only multiplied due to extended periods of vehicular usage caused by traffic congestion. Further personal vehicles require permanent dedicated areas for parking, limiting the endpoint options during transit.

Public transportation alleviates many of the environmental repercussions of personalized vehicles. Public transportation such as subway and bus systems reduce the net Carbon emissions per passenger compared to personalized vehicles. However, public transportation must account for optimal routes and destinations based on their average passengers. Public transportation often lacks flexibility to change from its predetermined routes connect passengers to their ultimate destinations. That is public transportation provides transportation to general designated locations but leaves the individual user responsible for traversing between the designated locations and their ultimate destinations. While public transportation often can arrive at a destination within a few miles of any particular urban destination, certain passengers face challenges traversing the remaining distance. For instance, individuals with mobility restrictions can find it difficult to arrive at public transportation locations.

Self-piloted transportation devices provide individuals with micro-mobility travel options. Self-piloted transportation devices may include bicycles, electric scooters, and electric bicycles. These self-piloted devices provide flexible and environmentally friendly travel across short distances. However, like public transportation the self-piloted devices face limits associated with pick-up and drop-off locations. Some self-piloted transportation devices may only be picked-up and dropped-off at designated docking stations. Thus, requiring travel to and from such stations. Self-piloted devices without designated docking stations subject users to availability in that area. Further self-piloted devices have usage barriers in terms of health, age, and physical ability of the individuals, as well as additional safety concerns. Additionally, most of the currently available self-piloted transportation devices expose their users to environmental and weather conditions.

As a result of these issues in the current systems of transportation, there exists an unmet need for an environmentally friendly, safe, and accessible micro-mobility solution.

### SUMMARY

Various embodiments of the invention relate to powered rickshaws and, more particularly, to systems and methods for enhancing the integration of powered rickshaws into micro-mobility on demand transportation environments. The invention may apply to vehicular devices or transportation environments. There is provided, in accordance with an example of the disclosed technology a method for providing on-demand transit services. The method can include receiving, by a computing system, information relating to a voucher from a user device. The voucher can be from a vendor. The voucher can be exchangeable by a user for a discount on a cost of a ride from the on-demand transit service. The method can include receiving, by the computing system, a request for a ride from the on-demand transit service from the user device. The request can be generated by a rider application on the user device. The request can include at least a current location of the user device, a transit destination requested by the user, and information relating to the voucher. The method can include determining, by the computing system, a cost for the ride from the on-demand transit service. The cost for the ride from the on-demand transit service can be based at least in part on the information relating to the voucher. The method can include sending, by the computing system, a request to a transit service provider device. The request can be received by a driver application on the transit service provider device. The request can include at least the current location of the user device and the transit destination requested by the user.

The disclosed technology can include a system for providing on-demand transit services. The system can include one or more processors. The system can include a memory. The memory can be communication with the one or more processors and storing instructions that, when executed by the one or more processors, can be configured to cause the system to: receive information relating to a voucher from a user device. The voucher can be from a vendor. The voucher can be exchangeable by a user for a discount on a cost of a ride from the on-demand transit service. The memory can be communication with the one or more processors and storing instructions that, when executed by the one or more processors, can be configured to cause the system to: receive a request for a ride from the on-demand transit services from the user device. The request can be generated by a rider application on the user device. The request can include at least a current location of the user device, a transit destination requested by the user, and information relating to the voucher. The memory can be in communication with the one or more processors and storing instructions that, when executed by the one or more processors, can be configured to cause the system to: determine a cost for the ride from the on-demand transit service. The cost for the ride can be based at least in part on the information relating to the voucher. The memory can be communication with the one or more processors and storing instructions that, when executed by the one or more processors, can be configured to cause the system to: send a request to a transit service provider device. The request can be received by a driver application on the transit service provider device. The request can include at least the current location of the user device and the transit destination requested by the user.

The disclosed technology can include a system for providing on-demand transit services. The system can include one or more processors. The system can include a memory. The memory can be communication with the one or more processors and storing instructions that, when executed by the one or more processors, are configured to cause the system to: receive information relating to a voucher from a user device. The voucher can be from a vendor. The voucher can be exchangeable by a user for a discount on a cost of a ride from the on-demand transit service. The memory can be in communication with the one or more processors and storing instructions that, when executed by the one or more processors, can be configured to cause the system to: receive a request for a ride from the on-demand transit services from the user device. The request can be generated by a rider application on the user device. The request can include at least a current location of the user device, a transit destination requested by the user, and information relating to the voucher. The memory can be communication with the one or more processors and storing instructions that, when executed by the one or more processors, are configured to cause the system to: determine a cost for the ride from the on-demand transit service. The cost for the ride from the on-demand transit service can be based at least in part on the information relating to the voucher, a distance between the current location of the user device and the transit destination requested by the user, and a current demand for the on-demand transit service. The current demand can be based at least in part on the number of users and number of transit service providers in a geographical area. The memory can be communication with the one or more processors and storing instructions that, when executed by the one or more processors, are configured to cause the system to: send a request to a transit service provider device. The request can be received by a driver application on the transit service provider device. The request can include at least the current location of the user device and the transit destination requested by the user.

### BRIEF DESCRIPTION OF THE FIGURES

Reference will now be made to the accompanying figures, which are not necessarily drawn to scale, and wherein:

FIG. 1 is a flow diagram of an example method, in accordance with an example embodiment of the presently disclosed subject matter.

FIG. 2 is a block diagram of an example system, in accordance with an example embodiment of the presently disclosed subject matter.

FIG. 3A is a perspective view of a powered rickshaw, in accordance with an example embodiment of the presently disclosed subject matter.

FIG. 3B is a side view of a powered rickshaw, in accordance with an example embodiment of the presently disclosed subject matter.

FIG. 3C is a side view of a powered rickshaw, in accordance with an example embodiment of the presently disclosed subject matter.

FIG. 3D is a front view of a powered rickshaw, in accordance with an example embodiment of the presently disclosed subject matter.

FIG. 3E is a back view of a powered rickshaw, in accordance with an example embodiment of the presently disclosed subject matter.

### DETAILED DESCRIPTION

To facilitate an understanding of the principles and features of embodiments of the invention, various illustrative embodiments are explained below. Although exemplary embodiments of the invention are explained in detail, other embodiments are contemplated. Further, in describing the exemplary embodiments, specific terminology will be resorted to for the sake of clarity. It is not intended that the invention is limited in its scope to the details of construction and arrangement of components set forth in the following description or illustrated in the drawings. The invention is capable of other embodiments and of being practiced or carried out in various ways.

An exemplary embodiment of the micro-mobility transportation solution may comprise a powered rickshaw and systems for operation of the same. For example, the powered rickshaw may include an environmentally friendly power system. The powered rickshaw may be designed for travel across multiple mediums present in urban living. In some embodiments the powered rickshaw may be in connection with remote databases to share information. The powered rickshaw may be designed with safety measures in mind, including but not limited to mounted cameras, automatic course-correction, and licensed drivers.

Other aspects of the current disclosure may include systems of operation for micro-mobility transportation solutions. These systems may include improved routing systems accounting for various mediums of transportation, i.e., sidewalks, roads, bike paths. Other systems may include weather integrated solutions capable of adjusting the system to account for weather forecasts and offer additional services based on such. Another system of the disclosure can integrate with external databases to adjust the schedule and availability of the micro-mobility transportation based on information received from those databases. Further systems of the embodiment may integrate with the environment surrounding the micro-mobility transportation solution.

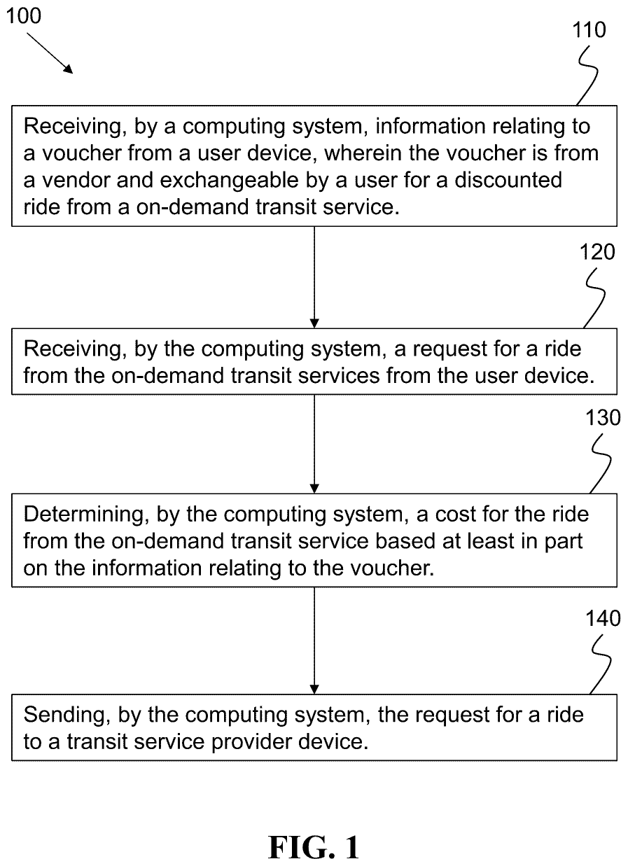

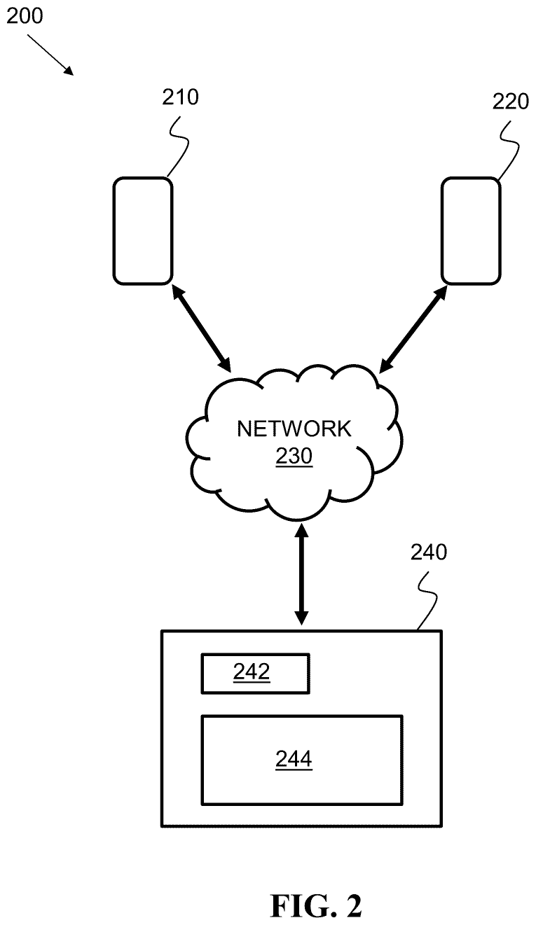

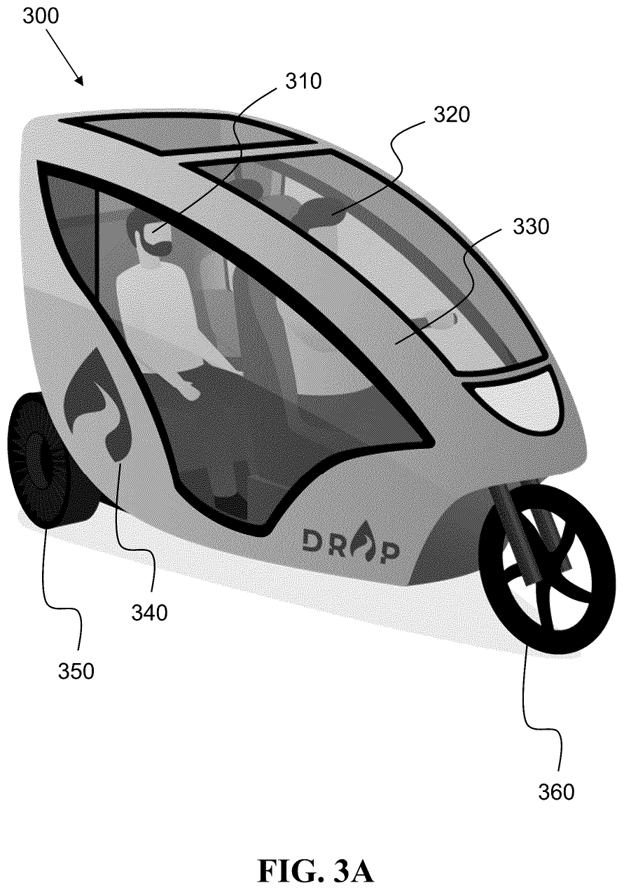

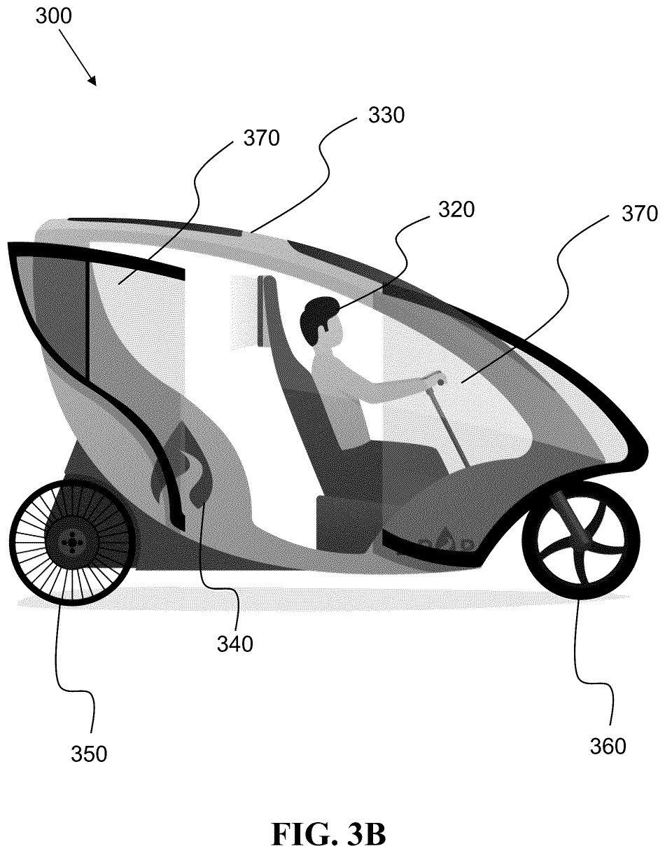

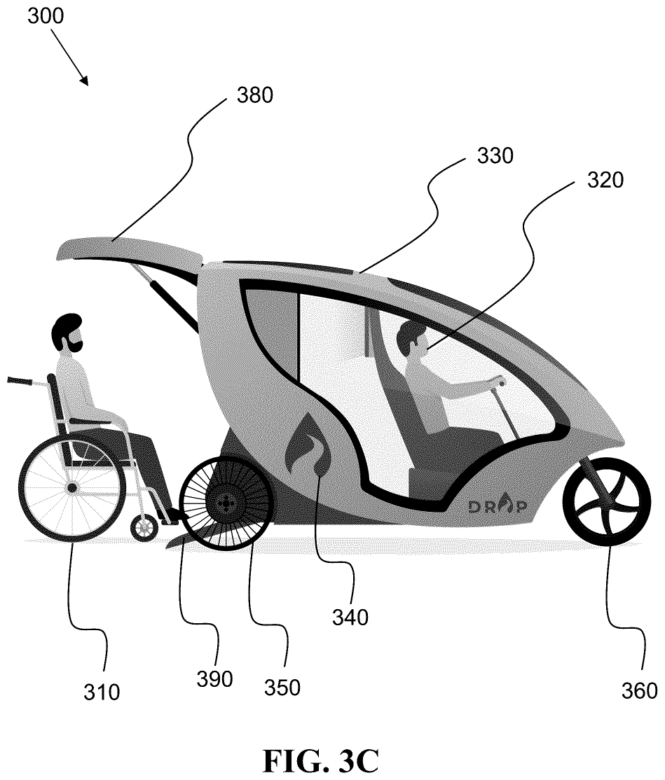

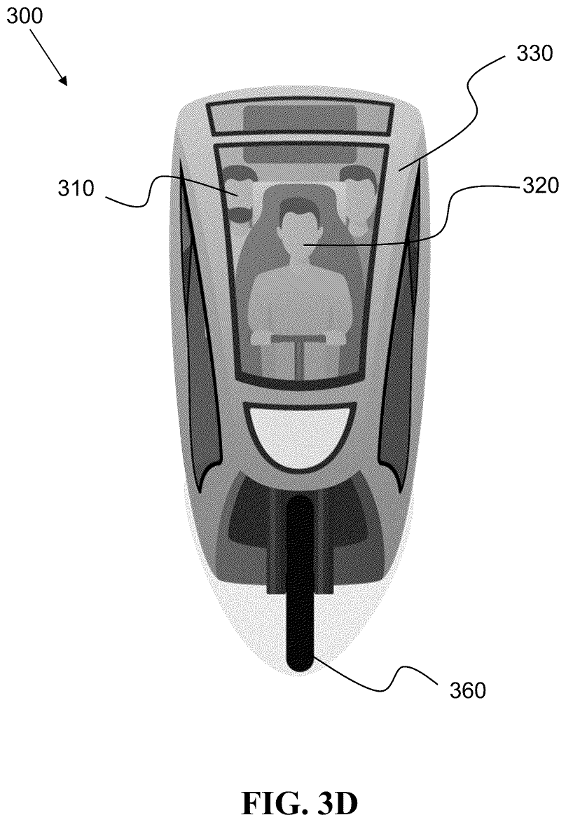

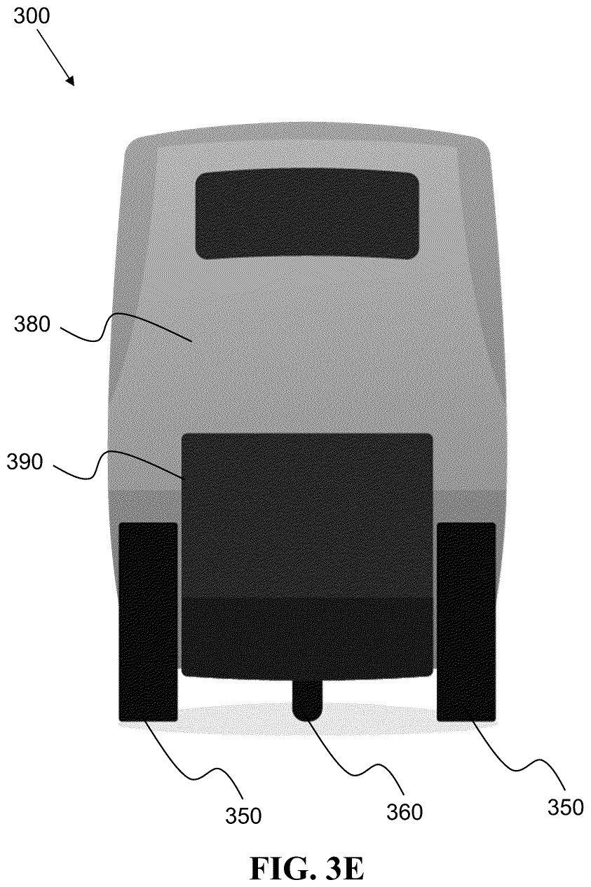

Referring now to the drawings, FIG. 1 illustrates an example embodiment of a method 100 for providing on-demand transit services. For example, the method 100 can be for providing on-demand transit services wherein a user can request transportation by powered rickshaw from one location to a destination. For example, the transportation can be provided by powered rickshaw 300 as described in more detail with respect to FIGS. 3A-E. The method 100 can further include the user receiving a voucher for a discounted ride with the on-demand transit service from a vendor where the user is a customer. The steps of method 100 can be performed by one or more components of the system 200 as described in more detail with respect to FIG. 2.

The method 100 can include receiving 110, by the computing system, information relating to a voucher. The information relating to the voucher can be received from a user device. The voucher can be provided from a vendor and redeemed by a user for one or more discounted or free rides with the on-demand transit service. For example, a user can visit a place of business and can receive the voucher as a customer of that business. Alternatively, or in addition, the user can be provided to a user as a promotional benefit. For example, a government group, such as a local municipality, may provide users in a certain geographical area vouchers. Groups may also provide vouchers on certain days, such as for local festivals or events. The voucher can be provided to the user via a unique code that is given to the user. The user can then input that code into a user application that is used to request rides through the on-demand transit service. For example, the user can use a rider application that has been downloaded on their own device, such as a smartphone, tablet, or computer. Alternatively, or in addition, the user can receive the voucher via a camera-based scanning technique. For example, the user can scan a QR code provided by the vendor. Alternatively, or in addition, the user can receive the voucher through other camera-based scanning methods known in the art such as bar codes, SnapTags, Miscrosoft Tag, Data Matric, and the like, or any combination thereof. Alternatively, or in addition the user can receive an electronic voucher. The electronic voucher can be provided over a network. For example, a user can receive a text message or email with a link to activate the voucher. The voucher can be provided automatically when a receipt is generated after a purchase from the vendor. For example, the receipt can include the voucher and be accessible to the user through any of the methods discussed herein, such as a unique code, scannable feature, or link. The receipt can be physical and/or digital. In addition, activation of the voucher by the user can cause the user device to automatically request a ride from the on-demand transit service. The automatic request can be for the on-demand transit service to pick up the user from the current location of the user. For example, the user can scan a QR code for the voucher causing the user device to automatically request a ride come pick up the user at the current location of the user.

The method 100 can include receiving 120, by the computing system, a request for a ride from a user. The ride can be from the on-demand transit system. For example, the user can use a rider application on their own device to request a ride from a powered rickshaw that is being operated by a service provider. The user can input the location they want to be picked up from. Alternatively, or in addition, the rider application can determine the current location of the user device using location determination systems known in the art such as GNSS system and/or inertial navigation. The user can further input a destination, or a plurality of destination, the user would like to stop at or be dropped off at by the on-demand transit system. The request for a ride from the user can further include information relating to the voucher. For example, the voucher amount and/or discount percentage can be provided to the computing system. The computing system can be a central computing system used to connect users and ride service providers and to receive and send requests for the on-demand transit system between these groups.

The method 100 can include determining 130, by the computing system, a cost for the ride. The cost for the ride can be determined based at least in part on the information relating to the voucher. Alternatively, or in addition, the cost of the ride can be determined based on the distance of the requested trip between the pickup location and destination. Alternatively, or in addition, the cost of the ride can be determined based on a current demand for the on-demand transit service. The current demand can be based at least in part on the number of user's in a geographical area. For example, the demand can be based at least in part on the number of user's that are requesting rides, currently riding, and/or are scheduled to have rides. Alternatively, or in addition, the demand can be based at least on part on the number of transit service providers in the geographical area. For example, the demand can be based at least in part on the number of transit service providers that are currently accepting riders, are scheduled to drop off riders soon and then by free to accept new riders, and/or are scheduled to begin working and accepting riders. Alternatively, or in addition, the determining 130 can be performed by the user device. For example, the rider application on a user device can determine the cost of the ride and then send that cost along with the request for a ride to the transit service provider, either directly, or through the computing system.

The method 100 can include sending 140, by the computing system, the request for a ride to a transit service provider. The transit service provider can be a driver of a powered rickshaw. The ride request can be sent to a transit service provider that is available, or is scheduled to soon become available (e.g., finishing another ride and/or scheduled to begin accepting rides) and in close proximity to the user's desired pick-up location. For example, the nearest transit service provider can be determined by comparing the user's pick-up location to the location of one or more transit service providers. Alternatively, or in addition, the estimated time to travel, based on available routes between the user's pick-up locations and one or more transit service providers locations can be used to determine which transit service provider should receive the request. In addition, the transit service provider can receive the request and can either accept or decline the ride request. If declined, the request can be sent to another transit service provider. This process can be repeated until a transit service provider accepts the ride request and picks up the user.

FIG. 2 illustrates a block diagram of an example system 200, according to an example implementation of the disclosed technology. The components and arrangements shown in FIG. 2 are not intended to limit the disclosed embodiments as the components used to implement the disclosed processes and features may vary. System 200 can include a user device 210, a transit service provider device 220, and a computing system 240. As shown, computing system 240 may interact with a user device 210 via a network 230. Alternatively, or in addition, the computing system 240 may interact with a transit service provider device 220 via a network 230.

In some embodiments, a user may operate the user device 210. The user device 210 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 230 and ultimately communicating with computing system 240. In some embodiments, the user device 210 may include or incorporate electronic communication devices for hearing or vision impaired users.

According to some embodiments, the user device 210 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

In some embodiments, a transit service provider may operate the transit service provider device 220. The transit service provider device 220 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 230 and ultimately communicating with computing system 240. In some embodiments, the transit service provider device 220 may include or incorporate electronic communication devices for hearing or vision impaired users.

According to some embodiments, the transit service provider device 220 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 230 may be of any suitable type, including individual connections via the internet such as cellular or WiFi networks. In some embodiments, the network 230 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 230 may include any type of computer networking arrangement used to exchange data. For example, the network 230 may be the Internet, a private data network, virtual private network (VPN) using a public network, and/or other suitable connection(s) that enable(s) components in the system 200 environment to send and receive information between the components of the system 200. The network 230 may also include a PSTN and/or a wireless network.

The computing system 240 can include one or more processors 242 and memory 244. The processor 242 may include one or more of a microprocessor, microcontroller, digital signal processor, co-processor or the like or combinations thereof capable of executing stored instructions and operating upon stored data. The memory 244 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 244.

The processor 242 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 242 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 242 may be a single core processor that is configured with virtual processing technologies. In certain embodiments, the processor 242 may use logical processors to simultaneously execute and control multiple processes. The processor 242 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

The memory 244 may include one or more memory devices that store data and instructions used to perform one or more features of the disclosed embodiments. The memory 244 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 244 may include software components that, when executed by the processor 242, perform one or more processes consistent with the disclosed embodiments.

FIGS. 3A-E illustrates an example embodiment of a powered rickshaw 300. The powered rickshaw 300 can be configured to carry one or more users 310. The powered rickshaw 300 can be operated by a transit service provider 320. The powered rickshaw 300 can be an electric powered rickshaw. The electric powered rickshaw can include one or more batteries. The one or more batteries can be removeable and can be remotely charged. The one or more batteries can additionally be interchangeable with other batteries, such that remotely charged batteries can be quickly swapped with dead or dying batteries. Alternatively, or in addition, the electric rickshaw can include a charging connection for direct charging the powered rickshaw 300. The one or more batteries can power one or more electric motors configured to turn one or more wheels. For example, the one or more electric motors can be configured to turn the rear wheel or wheels of the powered rickshaw 300. Alternatively, or in addition, the one or more motors can be configured to turn the front wheel or wheels of the powered rickshaw 300. Alternatively, or in addition, the powered rickshaw 300 can be powered by internal combustion. In addition, the powered rickshaw 300 can be powered by human power. For example, the powered rickshaw 300 can include pedals for powering the rickshaw 300 using human power in combination with other power sources, or alone. Alternatively, the pedals can be used to recharge a battery that powers the powered rickshaw 300.

The powered rickshaw 300 can include a frame. The frame can be made from a rigid and strong material, such as steel, titanium, carbon fiber, and aluminum. The powered rickshaw 300 can include a canopy 330. The canopy 330 can be made at least partially of plastic or other lightweight materials, such as carbon fiber. The canopy 330 can be configured to protect the riders and driver from the elements, such as rain. The canopy 330 can further include one or more windows. In addition, the canopy can include one or more displays 340. For example, the displays 340 can be used to show advertisements or the logo of the transit company. The displays 340 can be electronic displays that can be changed and controlled by a user. For example, the displays 340 can be screens, such as LED, LCD, OLED, QLED, Plasma, and the like, and can be configured to show images or play video.

The powered rickshaw 300 can include one or more rear wheels 350. For example, the powered rickshaw 300 can include two rear wheels 350. The rear wheels 350 can be airless tires. The powered rickshaw 300 can include one or more front wheels 360. For example, the powered rickshaw 300 can include a single front wheel 350.

The powered rickshaw 300 can include one or more doors 370 for entering and exiting the powered rickshaw 300. For example, the doors 370 can be sliding doors. Alternatively, or in addition the doors 370 can be swinging and/or lifting doors. The doors 370 can be located on one or both sides for the powered rickshaw 300. For example, the doors 370 can be located on one side of the powered rickshaw 370 and additional displays 340 can be located on the opposite side. Alternatively, or in addition, the powered rickshaw 300 can include a rear door 380. As illustrated in FIG. 3C, the rear door 380 can be a lifting door, such as a lifting hatch. The rear door 380 can be configured to allow wheelchair access in and out of the powered rickshaw 300. In addition, the powered rickshaw can include a ramp and/or lift 390 for assisting with wheelchair access in and out of the powered rickshaw 300.

### A. Design Considerations for Some Embodiments

Below are some considerations that may be made while developing an embodiment of the powered rickshaw. It will be understood that not all considerations may apply to every embodiment of the invention, and considerations not provided below may also be applicable.

The powered rickshaw may include one or more systems for providing power to the rickshaw. The power systems allow the powered rickshaws to operate in an environmentally friendly, yet efficient manner. In some embodiments the powered rickshaw may include a battery system for providing electrical power to the rickshaw. The battery system can be charged, and subsequently recharged, by external sources including electrical charging stations, solar panels, and conversion of mechanical energy from actions such as pedaling. The battery system can provide power to enable the rickshaw to travel across a variety of urban environments and at speeds appropriate for urban transportation. The battery system can be readily replaceable. The battery system can be charged when placed in the powered rickshaw or can be charged when isolated form the powered rickshaw.

Embodiments of the powered rickshaw may include features promoting safety for users. The powered rickshaws may be designed for travel across the multiple mediums present in urban living. The powered rickshaws may be sized to traverse along roadways, sidewalks, and bike paths. Similarly, the rickshaws may be designed for easy visibility and protection for use on roadways. Powered rickshaws may be designed with specialized frames, cameras, adaptable passenger seating, and traffic indicators. The frames may shelter users from environmental and external hazards while providing structural integrity for the rickshaw. Cameras on the rickshaw may provide assistance in course correction, and records for events occurring near and around the rickshaws. Adaptable passenger seating may allow a variety of users who could not operate a vehicle or other transportation device to utilize the rickshaw for transportation. Traffic indicators including blinkers, brake lights, and headlights, can promote visibility of the powered rickshaw in operation.

The powered rickshaw design may include a driver position as well as storage and passenger areas. The powered rickshaw can be piloted by full time drivers, be available for individual user operation, or be capable of autonomous operation. Mounted cameras on the powered rickshaw may enable autonomous operation. The passenger area allows users otherwise incapable of operating transportation devices to travel, for example the passenger area can be adapted to allow for wheelchair access. The passenger area may be adapted for seating of a single or multiple passengers. The passenger area may be adapted to include a ramped entrance. The passenger area may include a side or rear door. The storage areas may provide a secure location for materials during transport without restraining the rickshaw operator.

Some embodiments of the powered rickshaw can include comfort features. The powered rickshaws may include AC units, heaters, fans, cupholders, refrigerated sections, heated sections, privacy screeners, tablets, screens, and speakers. These features can provide entertainment or informational functionalities for the operator and passenger. These features may be adapted for delivery services, such as delivery of hot and cold food or delivery of parcels. In certain environments, the features can provide use protected from environmental deterrents such as extreme heat or cold.

Some embodiments of the powered rickshaw can include screens integrated with the frame of the powered rickshaw. The screens may be LED screens. The screens may be rigid or of a flexible material. The screens may be partially transparent. The screens may display advertising materials or may be configurable for visual appearance as preferred by the operator or passengers. The screens may be configured to communicate information to the public, for example the screens may display public safety information received from city services. The screens may display visuals for use in augmented reality, for example in an augmented reality history tour of a city, the screens may display the powered rickshaws as vehicles appropriate for the historical setting.

### B. Exemplary Integration Systems for Micro-Mobility Transpiration

The present invention further provides integration systems for improved use of micro-mobility transportation. In describing the integration systems, a powered rickshaw will be referenced for a micro-mobility transportation device, however the integration systems are not so limited for use only in connection with powered rickshaws. Below are some considerations that may be made while developing an embodiment of an integration system for improved use of micro-mobility transportation. It will be understood that not all considerations may apply to every embodiment of the invention, and considerations not provided below may also be applicable. It will be further understood that the inclusion of one embodiment of the invention is not at the exclusion of other embodiments.

One integration system may connect a powered rickshaw with an external system or database. For example, an integration system may be associated, and in communication with, both a hotel booking database and a powered rickshaw. Based off certain reporting metrics in the hotel database, the integration system could provide instructions to the powered rickshaw. For example, suppose a hotel offers shuttle services to their guests. However, during periods of high reservation rates, the hotel's shuttles cannot meet the demands of its guests. The integration system could automatically route available rickshaws to the hotel during peak hours when the hotel reports above the pre-determined metrics. The powered rickshaws could then to act as supplementary shuttle services for that hotel. Other examples of a hotel integration system could allow a hotel or other associated businesses to request rickshaws on behalf of their guests. The requestor could identify the pickup and drop off locations, or the requestor could defer the drop off location to the guest.

Another integration system may comprise a mobile application connecting powered rickshaws with mobile devices. A feature of the mobile application could allow for reservations of a powered rickshaw for a mobile device user. One aspect of the mobile application can allow a mobile device user to access a nearby powered rickshaw on-demand, while another aspect can allow a mobile device user to request a powered rickshaw to arrive at a requested location for pickup. The mobile application could function as a subscription service allowing a predetermined number of rides or distance travelled at a set recurring fee. The mobile application could also operate on a per ride charging basis, in which the mobile device user could be charged according to multiple factors such as distance travel, time of operation, or availability verse demand of the powered rickshaws.

The mobile application can be in communication with the geographic location sensor of the mobile device and can record geographic data information with the associated mobile device. The mobile application can additionally be in contact with other databases, such as geographic weather information. One feature of the mobile application can be to provide push notifications to mobile device users based on data received. For example, if the recorded geographic data: 1) indicates the mobile device user has walked away from his or her home distance; and 2) the geographic weather data shows storms in that area, then the mobile application can deliver a push notification to the mobile user device for a powered rickshaw pickup. The mobile application can be in connection with other mobile applications and e-services. For example, the mobile application can be connected to online reservation services. The mobile application can prompt a customer for a powered rickshaw ride to his or her reservation should the mobile application determine the customer is within a predetermined distance to the reservation. In another example the mobile application could be connected to an online check paying service and provide a notification for a powered rickshaw pickup upon payment of the check.

A further integration system may comprise a routing service for powered rickshaw. The routing system can account for the various urban mediums a powered rickshaw can traverse, e.g., sidewalks, roadways, bike trails. The routing system can be designed to learn based off recorded data of powered rickshaws. The routing system can account for periods of heavy traffic or congestion in the various traveling mediums and adjust the powered rickshaw routes accordingly. The routing system can connect to geographic weather databases, learn from recorded data from powered rickshaws during weather events, and adjust routes accordingly. For example, the routing system could learn that during periods of rain in certain geographic areas, sidewalk congestion decreases and travel by such mediums hasten. The routing system could then favor sidewalk travel for routes during similar periods of rain. The same route adjustment could result for other environmental factors such as extreme heat or cold.

The routing system can be designed around one or more metrics. The routing system may allow for a passenger to choose a route based around a given metric, or the routing system may predesignate the metric(s). One metric can be to provide the fastest route across the multiple mediums the powered rickshaw can traverse. Another metric can be to provide the route for minimal total distance travelled. In the case of a rickshaw with a battery system charged by solar power, the routing system can provide routes intersecting areas of optimal sunlight. Further metrics can account for higher rates of cost per mile for the digital ads associated with the exterior of the rickshaw to be seen. An additional metric can provide a route with the most scenic views or historical sites along the route.

Another integration system may connect powered rickshaws with other vehicular services. For example, the powered rickshaws could connect with a database for a city's emergency services. The integration system may access data received from the emergency services, such as location data for calls made to the emergency services. The integration system could determine, based on mapping systems, whether the location data correlates to an area non-accessible by emergency vehicles, e.g., a biking trail. Upon a determination of a non-accessible area, the integration system can direct a powered rickshaw to either the location of the location data received, or a location determined to be the nearest access point for the emergency vehicle compared to the location data received. The powered rickshaw can then be utilized to transport emergency services to the are for the location data or could transport an individual at the are of the location data to the emergency services. In a different example, the powered rickshaws can connect with personal transportation services, such as rideshare. The integration system may access data received from the personal transportation services, such as final destination location data. The integration system could determine, based on mapping systems, whether the final destination location data correlates to an area non-accessible by the personal transportation services. Upon a determination of a non-accessible area, the integration system can direct a powered rickshaw to a location determined to be the nearest access point for the personal transportation services, and the rider can use the powered rickshaw to complete his or her travel.

An additional integration system can connect city support and/or repair services to the powered rickshaw. The integration system can access cameras mounted on the powered rickshaws and record video taken therefrom. The integration system can then review the recorded videos and can determine events to be flagged to the city services. For example, the recorded video can determine whether a light pole has been hit, whether a light is out, or structural faults in the travel mediums, e.g., potholes. The flagged events can be communicated to city services for review and repair.

Another integration system can comprise a virtual tramline for powered rickshaws. The integration system can determine routes of high traffic and offer a predetermined point to point service along such route. The system can allow for pickup and drop off requests along the route.

A further integration system can connect augmented and/or virtual reality systems with the powered rickshaw. The integration system can receive location data and/or video recordings from the powered rickshaw. The integration system can simultaneously access an augmented and/or virtual reality system, the augmented and/or virtual reality system can be attached and/or powered by the powered rickshaw. The integration system can feed data received from the powered rickshaw to display specific events in the augmented and/or virtual reality system. For example, the integration system could reproduce movie sets or screens filmed at the location data received by the powered rickshaw. As another example the integration system could reproduce local footage available from historical archives to be overlayed and displayed corresponding to the location data received by the powered rickshaw in comparison to the location of historical sites.

The powered rickshaw and integration system have been disclosed in exemplary forms, it will be apparent to those skilled in the art that many modifications, additions, and deletions may be made without departing from the spirit and scope of the system, method, and their equivalents, as set forth in claims to be filed in a later non-provisional patent application.

The disclosed technology described herein can be further understood according to the following clauses:

Clause 1: A method for providing on-demand transit services comprising: receiving, by a computing system, information relating to a voucher from a user device, wherein the voucher is from a vendor, the voucher being exchangeable by a user for a discount on a cost of a ride from the on-demand transit service; receiving, by the computing system, a request for a ride from the on-demand transit service from the user device, the request being generated by a rider application on the user device, the request including at least a current location of the user device, a transit destination requested by the user, and information relating to the voucher; determining, by the computing system, a cost for the ride from the on-demand transit service, wherein the cost for the ride from the on-demand transit service is based at least in part on the information relating to the voucher; and sending, by the computing system, a request to a transit service provider device, the request being received by a driver application on the transit service provider device, the request including at least the current location of the user device and the transit destination requested by the user.

Clause 2: The method of clause 1, wherein the determining the cost for the ride from the on-demand transit service is based at least in part on a distance between the current location of the user device and the transit destination requested by the user.

Clause 3: The method of clause 1, wherein the determining the cost for the ride from the on-demand transit service is based at least in part on a current demand for the on-demand transit service, wherein the current demand is based at least in part on the number of users and number of transit service providers in a geographical area.

Clause 4: The method of clause 1, wherein the on-demand transit service is a powered rickshaw-based transit service.

Clause 5: The method of clause 4, wherein the powered rickshaw-based transit service comprises electric-powered rickshaws.

Clause 6: The method of clause 1, wherein the user device received the information relating to the voucher via a QR code.

Clause 7: The method of clause 1, wherein the user device received the information relating to the voucher via a network.

Clause 8: The method of clause 1, wherein the rider application and the driver application are the same application.

Clause 9: A system for providing on-demand transit services comprising: one or more processors; and a memory in communication with the one or more processors and storing instructions that, when executed by the one or more processors, are configured to cause the system to: receive information relating to a voucher from a user device, wherein the voucher is from a vendor, the voucher being exchangeable by a user for a discount on a cost of a ride from the on-demand transit service; receive a request for a ride from the on-demand transit services from the user device, the request being generated by a rider application on the user device, the request including at least a current location of the user device, a transit destination requested by the user, and information relating to the voucher; determine a cost for the ride from the on-demand transit service, wherein the cost for the ride from the on-demand transit service is based at least in part on the information relating to the voucher; and send a request to a transit service provider device, the request being received by a driver application on the transit service provider device, the request including at least the current location of the user device and the transit destination requested by the user.

Clause 10: The system of clause 9, wherein the cost for the ride from the on-demand transit service is based at least in part on a distance between the current location of the user device and the transit destination requested by the user.

Clause 11: The system of clause 9, wherein the cost for the ride from the on-demand transit service is based at least in part on a current demand for the on-demand transit service, wherein the current demand is based at least in part on the number of users and number of transit service providers in a geographical area.

Clause 12: The system of clause 9, wherein the on-demand transit service is a powered rickshaw-based transit service.

Clause 13: The system of clause 12, wherein the powered rickshaw-based transit service comprises electric-powered rickshaws.

Clause 14: The system of clause 9, wherein the user device received the information relating to the voucher via a QR code.

Clause 15: The system of clause 9, wherein the user device received the information relating to the voucher via a network.

Clause 16: The system of clause 9, wherein the rider application and the driver application are the same application.

Clause 17: A system for providing on-demand transit services comprising: one or more processors; and a memory in communication with the one or more processors and storing instructions that, when executed by the one or more processors, are configured to cause the system to: receive information relating to a voucher from a user device, wherein the voucher is from a vendor, the voucher being exchangeable by a user for a discount on a cost of a ride from the on-demand transit service; receive a request for a ride from the on-demand transit services from the user device, the request being generated by a rider application on the user device, the request including at least a current location of the user device, a transit destination requested by the user, and information relating to the voucher; determine a cost for the ride from the on-demand transit service, wherein the cost for the ride from the on-demand transit service is based at least in part on the information relating to the voucher, a distance between the current location of the user device and the transit destination requested by the user, and a current demand for the on-demand transit service, wherein the current demand is based at least in part on the number of users and number of transit service providers in a geographical area; and send a request to a transit service provider device, the request being received by a driver application on the transit service provider device, the request including at least the current location of the user device and the transit destination requested by the user.

Clause 18: The system of clause 17, wherein the on-demand transit service is a powered rickshaw-based transit service.

Clause 19: The system of clause 17, wherein the user device received the information relating to the voucher via a QR code.

Clause 20: The system of clause 17, wherein the user device received the information relating to the voucher via a network.

While certain embodiments of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for providing on-demand transit services comprising:
receiving, by a computing system, information relating to a voucher from a user device, wherein the voucher is from a vendor, the voucher being exchangeable by a user for a discount on a cost of a ride from the on-demand transit service;
receiving, by the computing system, a request for a ride from the on-demand transit service from the user device, the request being generated by a rider application on the user device, the request including at least a current location of the user device, a transit destination requested by the user, and information relating to the voucher;
determining, by the computing system, a cost for the ride from the on-demand transit service, wherein the cost for the ride from the on-demand transit service is based at least in part on the information relating to the voucher; and
sending, by the computing system, a request to a transit service provider device, the request being received by a driver application on the transit service provider device, the request including at least the current location of the user device and the transit destination requested by the user.

2. The method of claim 1, wherein the determining the cost for the ride from the on-demand transit service is based at least in part on a distance between the current location of the user device and the transit destination requested by the user.

3. The method of claim 1, wherein the determining the cost for the ride from the on-demand transit service is based at least in part on a current demand for the on-demand transit service, wherein the current demand is based at least in part on the number of users and number of transit service providers in a geographical area.

4. The method of claim 1, wherein the on-demand transit service is a powered rickshaw-based transit service.

5. The method of claim 4, wherein the powered rickshaw-based transit service comprises electric-powered rickshaws.

6. The method of claim 1, wherein the user device received the information relating to the voucher via a QR code.

7. The method of claim 1, wherein the user device received the information relating to the voucher via a network.

8. The method of claim 1, wherein the rider application and the driver application are the same application.

9. A system for providing on-demand transit services comprising:
one or more processors; and
a memory in communication with the one or more processors and storing instructions that, when executed by the one or more processors, are configured to cause the system to:
receive information relating to a voucher from a user device, wherein the voucher is from a vendor, the voucher being exchangeable by a user for a discount on a cost of a ride from the on-demand transit service;
receive a request for a ride from the on-demand transit services from the user device, the request being generated by a rider application on the user device, the request including at least a current location of the user device, a transit destination requested by the user, and information relating to the voucher;
determine a cost for the ride from the on-demand transit service, wherein the cost for the ride from the on-demand transit service is based at least in part on the information relating to the voucher; and
send a request to a transit service provider device, the request being received by a driver application on the transit service provider device, the request including at least the current location of the user device and the transit destination requested by the user.

10. The system of claim 9, wherein the cost for the ride from the on-demand transit service is based at least in part on a distance between the current location of the user device and the transit destination requested by the user.

11. The system of claim 9, wherein the cost for the ride from the on-demand transit service is based at least in part on a current demand for the on-demand transit service, wherein the current demand is based at least in part on the number of users and number of transit service providers in a geographical area.

12. The system of claim 9, wherein the on-demand transit service is a powered rickshaw-based transit service.

13. The system of claim 12, wherein the powered rickshaw-based transit service comprises electric-powered rickshaws.

14. The system of claim 9, wherein the user device received the information relating to the voucher via a QR code.

15. The system of claim 9, wherein the user device received the information relating to the voucher via a network.

16. The system of claim 9, wherein the rider application and the driver application are the same application.

17. A system for providing on-demand transit services comprising:
one or more processors; and
a memory in communication with the one or more processors and storing instructions that, when executed by the one or more processors, are configured to cause the system to:
receive information relating to a voucher from a user device, wherein the voucher is from a vendor, the voucher being exchangeable by a user for a discount on a cost of a ride from the on-demand transit service;
receive a request for a ride from the on-demand transit services from the user device, the request being generated by a rider application on the user device, the request including at least a current location of the user device, a transit destination requested by the user, and information relating to the voucher;
determine a cost for the ride from the on-demand transit service, wherein the cost for the ride from the on-demand transit service is based at least in part on the information relating to the voucher, a distance between the current location of the user device and the transit destination requested by the user, and a current demand for the on-demand transit service, wherein the current demand is based at least in part on the number of users and number of transit service providers in a geographical area; and
send a request to a transit service provider device, the request being received by a driver application on the transit service provider device, the request including at least the current location of the user device and the transit destination requested by the user.

18. The system of claim 17, wherein the on-demand transit service is a powered rickshaw-based transit service.

19. The system of claim 17, wherein the user device received the information relating to the voucher via a QR code.

20. The system of claim 17, wherein the user device received the information relating to the voucher via a network.
